(19) United States
(12) Patent Application Publication
(10) Pub. No.: US 2026/0190074 A1
(43) Pub. Date: Jul. 2, 2026

(54) COMMUNICATION METHOD AND DEVICE

(71) Applicant: GUANGDONG OPPO MOBILE TELECOMMUNICATIONS CORP. , LTD., Dongguan, Guangdong (CN)

(72) Inventors: Haitao LI, Dongguan, Guangdong (CN); Yi HU, Dongguan, Guangdong (CN)

(73) Assignee: GUANGDONG OPPO MOBILE TELECOMMUNICATIONS CORP. , LTD., Dongguan, Guangdong (CN)

(21) Appl. No.: 19/129,557

(22) PCT Filed: Nov. 1, 2022
(86) PCT No.: PCT/CN2022/129000

§ 371 Date: May 13, 2025

(51) Int. Cl. H04W 64/00; H04W 36/00; H04W 36/08; H04W 76/27

(52) U.S. Cl. CPC H04W 64/006; H04W 36/0005; H04W 36/08; H04W 76/27

(57) ABSTRACT

The present application relates to a communication method and device, a computer-readable storage medium, a computer program product, and a computer program. The method comprises: a terminal device receives configuration information, the configuration information being used for configuring the terminal device to report global navigation satellite system (GNSS) related information.

### TECHNICAL FIELD

This application relates to the field of communications, and in particular to a communication method and device, a computer-readable storage medium, a computer program product, and a computer program.

### BACKGROUND

In the related art, discussions have been made on enhancement of capabilities of Internet of Things (IoT) terminals, including the capability of terminal devices to perform global navigation satellite system (GNSS) positioning operations. However, when should the terminal devices report the GNSS related information to the network so that the network configures appropriate measurement gaps for the terminal devices becomes a problem that needs to be solved.

### SUMMARY

Embodiments of the disclosure provide a communication method and device, a computer-readable storage medium, a computer program product, and a computer program.

There is provided a method for communication in an embodiment of the disclosure, and the method includes the following operation.

A terminal device receives configuration information, and the configuration information is used to configure the terminal device to report GNSS related information.

There is provided a method for communication in an embodiment of the disclosure, and the method includes the following operation.

A first network device transmits configuration information, and the configuration information is used to configure a terminal device to report GNSS related information.

There is provided a terminal device in an embodiment of the disclosure, and the terminal device includes a first communication unit.

The first communication unit is configured to receive configuration information, and the configuration information is used to configure the terminal device to report GNSS related information.

There is provided a first network device in an embodiment of the disclosure, and the first network device includes a second communication unit.

The second communication unit is configured to transmit configuration information, and the configuration information is used to configure a terminal device to report GNSS related information.

There is provided a terminal device in an embodiment of the disclosure, and the terminal device includes a processor and a memory. The memory is configured to store a computer program, and the processor is configured to invoke and execute the computer program stored in the memory to cause the terminal device to implement the method described above.

There is provided a first network device in an embodiment of the disclosure, and the first network device includes a processor and a memory. The memory is configured to store a computer program, and the processor is configured to invoke and execute the computer program stored in the memory to cause the first network device to implement the method described above.

There is provided a chip in an embodiment of the disclosure, and the chip is used to implement the method described above.

Specifically, the chip includes a processor, and the processor is configured to invoke and execute a computer program from a memory to cause a device on which the chip is mounted to implement the method described above.

There is provided a computer-readable storage medium in an embodiment of the disclosure. The computer-readable storage medium has stored thereon a computer program that, when executed by a device, causes the device to implement the method described above.

There is provided a computer program product in an embodiment of the disclosure. The computer program product includes computer program instructions that, when executed by a computer, cause the computer to implement the method described above.

There is provided a computer program in an embodiment of the disclosure. The computer program, when running on a computer, causes the computer to implement the method described above.

In embodiments of the disclosure, by adopting the above solutions, the terminal device may receive configuration information that configures the terminal device to report the GNSS related information. In this way, the terminal device can report the GNSS related information at an appropriate time according to the configuration from the network side, thereby ensuring that the network side configures an appropriate measurement gap for the terminal device.

### BRIEF DESCRIPTION OF THE DRAWINGS

FIG. 1 is a schematic diagram of a communication scenario.

FIG. 2 is a schematic flowchart of a method for communication according to an embodiment of the disclosure.

FIG. 3 is a schematic flowchart of a method for communication according to another embodiment of the disclosure.

FIG. 4 is an exemplary flowchart of a method for communication according to the disclosure.

FIG. 5 is an exemplary flowchart illustrating the process of a terminal device reporting GNSS related information again according to an embodiment of the disclosure.

FIG. 6 is an exemplary flowchart illustrating the process of a terminal device reporting GNSS related information when the terminal device is handed over from a second network device to a first network device according to an embodiment of the disclosure.

FIG. 7 and FIG. 8 are two exemplary flowcharts illustrating the process of network devices exchange GNSS related information when a terminal device is handed over from a first network device to a third network device according to an embodiment of the disclosure.

FIG. 9 is an exemplary flowchart illustrating the process of a terminal device reporting GNSS related information when the terminal device is handed over from a first network device to a third network device according to an embodiment of the disclosure.

FIG. 10 is a schematic block diagram of a terminal device according to an embodiment of the disclosure.

FIG. 11 is a schematic block diagram of a terminal device according to another embodiment of the disclosure.

FIG. 12 is a schematic block diagram of a first network device according to an embodiment of the disclosure.

FIG. 13 is a schematic block diagram of a communication device according to an embodiment of the disclosure.

FIG. 14 is a schematic block diagram of a chip according to an embodiment of the disclosure.

FIG. 15 is a schematic block diagram of a communication system according to an embodiment of the disclosure.

### DETAILED DESCRIPTION

The technical solutions in embodiments of the disclosure will be described below with reference to the accompanying drawings in embodiment of the disclosure.

The technical solutions in embodiments of the disclosure can be applied to various communication systems, such as: a global system of mobile communication (GSM) system, a code division multiple access (CDMA) system, a wideband code division multiple access (WCDMA) system, general packet radio service (GPRS), a long term evolution (LTE) system, an advanced long term evolution (LTE-A) system, a new radio (NR) system, an evolution system of NR system, a LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area networks (WLAN), wireless fidelity (WiFi), a 5th-generation (5G) systems or other communication systems, etc.

Generally, conventional communication systems support a limited number of connections and are easy to implement. However, with the development of communication technology, mobile communication systems will support not only conventional communication, but also support, for example, device to device (D2D) communication, machine to machine (M2M) communication, machine type communication (MTC), vehicle to vehicle (V2V) communication, or vehicle to everything (V2X) communication, etc. The embodiments of the disclosure may also be applied to these communication systems.

In one possible implementation, the communication system in the embodiment of the disclosure can be applied to a carrier aggregation (CA) scenario, a dual connectivity (DC) scenario, and a standalone (SA) networking scenario.

In one possible implementation, the communication system in the embodiment of the disclosure may be applied to an unlicensed spectrum, and the unlicensed spectrum may also be considered to be a shared spectrum. Alternatively, the communication system in the embodiment of the disclosure may also be applied to a licensed spectrum, and the licensed spectrum may also be considered as a non-shared spectrum.

Various embodiments are described in embodiments of the disclosure in connection with the network device and the terminal device. The terminal device may also be referred to as user equipment (UE), access terminals, subscriber units, subscriber stations, mobile stations, mobile stations, remote stations, remote terminals, mobile devices, user terminals, terminals, wireless communication devices, user agents or user devices, and the like.

The terminal device may be a station (ST) in a WLAN, may be a cellular telephone, a cordless telephone, a session initiation protocol (SIP) telephone, a wireless local loop (WLL) station, a personal digital assistant (PDA) device, a handheld device with wireless communication capabilities, a computing device or other processing device connected to a wireless modem, a vehicle-mounted device, a wearable device, a terminal device in a next generation communication system such as an NR network, or a terminal device in a future evolved public land mobile network (PLMN) network.

In embodiments of the disclosure, the terminal device may be deployed on land, including indoor or outdoor, handheld, wearable or vehicle-mounted device. The terminal device may also be deployed on the water (such as on ships, etc.). The terminal device may also be deployed in the air (e.g. in aircraft, in balloons and in satellites, etc.).

In embodiments of the disclosure, the terminal device may be a mobile phone, a Pad, a computer with a wireless transceiver function, a virtual reality (VR) terminal device, or an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, and the like.

By way of example and not limitation, in an embodiment of the disclosure, the terminal device may also be a wearable device. The wearable device may also be referred to as a wearable smart device, which is a general term of wearable devices that are intelligently designed and developed by applying wearable technologies to daily wear, such as glasses, gloves, watches, clothing and shoes. The wearable device is a portable device that is worn directly on the body or integrated into the user's clothes or accessories. The wearable device is not only a hardware device, but also realizes powerful functions through software support, data interaction and cloud interaction. Generalized wearable smart devices have full functions and large size, and may realize complete or partial functions without relying on smart phones, such as smart watches or smart glasses, as well as those that only focus on a certain type of application functions and need to be used in conjunction with other devices such as smart phones, such as various smart bracelets and smart jewelry for physical sign monitoring.

In embodiments of the disclosure, the network device may be a device for communicating with a mobile device. The network device may be an access point (AP) in WLAN, a base transceiver station (BTS) in GSM or CDMA, a NodeB (NB) in WCDMA, an evolutional Node B (eNB or eNodeB) in LTE, or a relay station or access point, or a vehicle-mounted device, a wearable device, a network device (gNB) in NR networks, a network device in future evolved PLMN networks, a network device in NTN networks, etc.

By way of example and not limitation, in an embodiment of the disclosure, the network device may have mobility characteristics, e.g., the network device may be a mobile device. In an example, the network device may be a satellite, a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In an example, the network device may also be a base station installed on land, in the water and in other locations.

In embodiments of the disclosure, the network device may provide services for a cell, and the terminal device communicates with the network device through transmission resources (e.g., frequency domain resources, or spectrum resources) used by the cell. The cell may be a cell corresponding to the network device (e.g., base station). The cell may belong to a macro base station or a base station corresponding to a small cell. The small cell may include a metro cell, a micro cell, a pico cell, a femto cell, and the like. These small cells have the characteristics of small coverage and low transmission power, and are suitable for providing high-speed data transmission services.

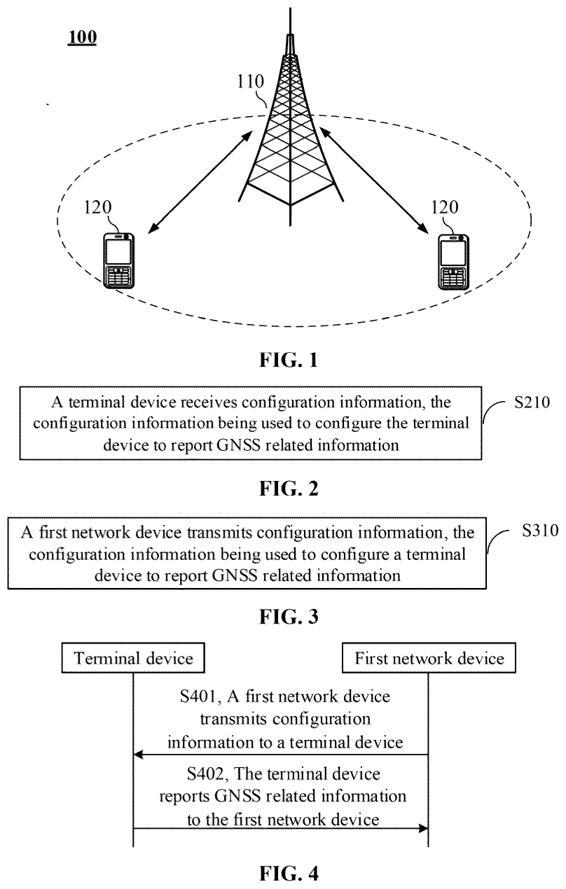

FIG. 1 exemplarily illustrates a communication system 100. The communication system includes a network device 110 and two terminal devices 120. In one possible implementation, the communication system 100 may include multiple network devices 110, and another number of terminal devices 120 may be included within the coverage of each network device 110, which is not limited in the embodiment of the disclosure.

In one possible implementation, the communication system 100 may also include other network entities such as a mobility management entity (MME), an access and mobility management function (AMF), and the like, which is not limited in the embodiments of the disclosure.

The network device may include an access network device and a core network device. That is to say, the wireless communication system also includes multiple core networks for communication with the access network device. The access network device may be an evolutional node B (referred to as an eNB or e-NodeB for short) macro base station, micro base station (also referred to as a “small base station”), a pico base station, an access point (AP), a transmission point (TP) in a long-term evolution (LTE) system, a next radio (NR) system or an authorized auxiliary access long-term evolution (LAA-LTE) system, or a new generation Node B (gNodeB), etc.

It should be understood that in the embodiments of the disclosure, a device having a communication function in a network/system may be referred to as a communication device. Taking the communication system illustrated in FIG. 1 as an example, the communication device may include a network device and a terminal device, both having a communication function, and the network device and the terminal device may be specific devices in the embodiment of the disclosure, which will not be described herein. The communication device may also include other devices in the communication system, such as other network entities such as a network controller, a mobility management entity, and the like, which is not limited in the embodiment of the disclosure.

In order to facilitate the understanding of embodiments of the disclosure, the basic processes and basic concepts involved in embodiments of the disclosure will be explained in brief. It should be understood that the basic processes and basic concepts described below do not constitute limitations on embodiments of the disclosure.

### Non Terrestrial Network (NTN)

NTN generally uses satellite communication to provide communication services to ground users. Compared with terrestrial cellular communication, the satellite communication has many unique advantages. First of all, satellite communication is not restricted by regions of users. For example, general land communication cannot cover areas such as oceans, mountains, deserts, etc. where communication devices cannot be installed or where communication coverage is not done due to sparse population. For satellite communication, every corner of the earth may be theoretically covered by satellite communication, because one satellite may cover a large area of the ground and satellites may orbit around the earth. Secondly, satellite communication has great social value. Satellite communication may be covered at a lower cost in remote mountainous areas, poor and backward countries or regions, so that people in these areas can enjoy advanced voice communication and mobile Internet technology, which is conducive to narrowing the digital divide with developed regions and promoting the development of these regions. Thirdly, satellite communication has a long distance, and the cost of communication does not increase significantly as the communication distance increases. Finally, satellite communication has a high stability and is not limited by natural disasters.

In order to ensure satellite coverage and improve the system capacity of the entire satellite communication system, satellites use multiple beams to cover the ground. One satellite can form dozens or even hundreds of beams to cover the ground. One satellite beam can cover ground areas with a diameter of tens to hundreds of kilometers. Communication satellites, based on their orbital altitudes, are classified into LEO (low-earth orbit) satellites, MEO (medium-earth orbit) satellites, GEO (geostationary earth orbit) satellites, HEO (high elliptical orbit) satellites and so on. Herein, LEO and GEO are mainly explained.

LEO: the altitude of a LEO satellite ranges from 500 km to 1500 km, and its corresponding orbital period is about 1.5 hours to 2 hours. The signal propagation delay of single-hop communication between users is generally less than 20 ms. The maximum satellite visibility time is 20 minutes. The signal propagation distance is short, the link loss is low, and the transmission power requirement of the user terminal is not high.

GEO: a geostationary earth orbit satellite with an orbital altitude of 35,786 km and a 24-hour rotation period around the earth. The signal propagation delay of single-hop communication between users is generally 250 ms.

In the related research, two NTN network architectures, transparent forwarding and regenerative forwarding, are mainly aimed at. The NTN network consists of the following network elements: one or more gateways, which is used to connect satellites and terrestrial public networks; a feeder link, which is a link for communication between the gateway and the satellite; a service link, which is a link for communication between the terminal and the satellite; inter-satellite links, which exist in the regenerative forwarding network architecture; and satellites, which functions in transparent forwarding and regenerative forwarding. The transparent forwarding provides only the functions of radio frequency filtering, frequency conversion and amplification. The transparent forwarding provides only transparent forwarding of signals without changing the waveform of the forwarded signals. The regenerative forwarding, in addition to providing the functions of radio frequency filtering, frequency conversion and amplification, may also provide the functions of demodulation/decoding, routing/conversion, encoding/modulation. The regenerative forwarding has some or all of the functions of the base station.

### Uplink Timing Advance in LTE/NR Terrestrial Network

An important feature of uplink transmission is that different UEs have orthogonal multiple access in time and frequency, that is, uplink transmissions from different UEs in the same cell do not interfere with each other. In order to ensure the orthogonality of uplink transmission and avoid intra-cell interference, the eNB/gNB requires that the times at which signals, sent by different UEs at the same time but in different frequency domain resources, arrive at the eNB/gNB are substantially aligned. In order to ensure time synchronization on the eNB/gNB side, LTE/NR supports an uplink timing advance mechanism.

The uplink clock and the downlink clock on the eNB/gNB side are the same, while there is an offset between the uplink clock and the downlink clock on the UE side, and different UEs have different uplink timing advances. The eNB/gNB may control the times at which uplink signals from different UEs arrive at the eNB/gNB by appropriately controlling the offset of each UE. For a UE farther away from the eNB/gNB, due to a large transmission delay, the uplink data needs to be transmitted ahead compared with a UE closer to the eNB/gNB.

The eNB/gNB determines a TA (timing advance) value for each UE by measuring the uplink transmission of the UE. The eNB/gNB transmits TA commands to the UE in the following two manners.

Acquisition of initial TA: in the random access procedure, the eNB/gNB determines the TA value by measuring the received preamble(s), and transmits the TA value to the UE through a field of Timing Advance Command in RAR.

Adjustment of TA in RRC (Radio Resource Control) connected state: although uplink synchronization has been achieved by the UE and the eNB/gNB during the random access procedure, the timing at which the uplink signal arrives at the eNB/gNB may change with time. Therefore, the UE needs to continuously update its uplink timing advance to maintain uplink synchronization. If the TA of a certain UE needs to be corrected, the eNB/gNB will transmit a Timing Advance Command to the UE and require the UE to adjust the uplink timing. The Timing Advance Command is transmitted to the UE through a Timing Advance Command MAC (medium access control) CE (control element).

### TA Maintenance in NTN

In the conventional TN (terrestrial network) network, UEs perform TA maintenance based on the TA commands issued by the network. For Rel-17 NTN, assuming that each UE has GNSS positioning capability and TA pre-compensation capability, the UE can estimate the service link TA by itself based on the position of the UE and the position of the serving satellite. Therefore, a determination method of TA combining open-loop and closed-loop approaches is introduced in the NTN. For an NTN UE in an RRC_IDLE state, in an RRC_INACTIVE state, or in an RRC_CONNECTED state, the TA of the NTN UE is calculated by the following formula:

$${T}_{TA} = ( {N}_{TA} + {N}_{TA , UE - specific} + {N}_{TA , common} + {N}_{TA , offset} ) \times {T}_{c}$$

Herein, N_{TA} is defined as 0 for the scenario of PRACH (physical random access channel) transmission, which may be subsequently updated by the TA command in message (Msg) 2/MsgB and the TA command MAC CE. N_{TA,UE-specific} is the serving link TA estimated by the UE for TA pre-compensation. Specifically, the UE obtains the position of the satellite based on the GNSS position information acquired by the UE itself in combination with the satellite ephemeris information broadcast by the serving cell, and calculates the propagation delay of the serving link from the UE to the satellite. N_{TA,UE-common} is a common TA controlled by the network, and includes any timing deviations deemed necessary by the network. N_{TA,offset} is a fixed offset for TA calculation.

As can be seen from the above formula, if the UE in the RRC connected state wants to acquire the serving link TA (i.e., N_{TA,UE-specific}), on the one hand, the UE needs to know its own GNSS position information, and on the other hand, the UE also needs to obtain the location of the serving satellite based on the satellite ephemeris information from the serving cell. In addition, in order to calculate the TA of the UE, the UE also needs to acquire the common TA (i.e. N_{TA,common}).

### GNSS Operations in R17 IoT NTN

In R17 IoT NTN (that is, the scenario of NB-IoT and eMTC accessing the NTN), the GNSS measurement module and the communication module in an IoT terminal cannot operate simultaneously (simultaneous GNSS and NTN NB-IoT/eMTC operation is not assumed). In R17 NTN, the IoT terminal may only perform GNSS measurement to obtain position information in the RRC IDLE or the RRC INACTIVE state, but cannot start the GNSS module in the RRC connected state. For this reason, the UE needs to measure and obtain its own GNSS position (i.e. GNSS measurement result) through the GNSS module before entering the RRC connected state. The UE may determine the valid time duration of the GNSS position based on its own conditions (such as the mobility state of the UE), and report the valid remaining time of the GNSS position to the network during RRC connection establishment/RRC connection reestablishment/RRC connection resume. For the UE in the RRC connected state, when the valid duration of its GNSS position expires, since the UE cannot perform the GNSS operation in the RRC connected state, the UE cannot calculate the TA, and thus the UE needs to return to the RRC IDLE state.

### GNSS Enhancement in R18 IoT NTN

The research objectives for the R18 IoT NTN mainly include: IoT-NTN performance enhancements in Rel-18 to address maintaining issues from Rel-17.

This work considers Rel-17 IoT-NTN as baseline as well as Rel-17 NR-NTN outcome and the further IoT-NTN performance enhancements objectives are listed below. Disabling of HARQ feedback to mitigate impact of HARQ stalling on UE data rate. Study and specify, if needed, improved GNSS operations for a new position fix for UE pre-compensation during long connection times and for reduced power consumption.

Based on the above research objectives, IoT terminals accessing the NTN in R18 will be able to perform GNSS operations in the RRC connected state. In the related discussion, the GNSS enhancement of the IoT terminals accessing the NTN is discussed, and the following conclusions are formed.

1. The IoT NTN UE may need to re-acquire a valid GNSS position fix during a longer RRC connection time duration. How can the UE update or reduce the need to update the GNSS position fix during the RRC connected state.

2. For the GNSS measurement in the connected state, at least the following candidate solutions may be considered. Method 1: the UE controlled based on the timer re-acquires the GNSS position fix; Method 2: a new gap is introduced, and the UE re-acquires the GNSS position fix during the gap.

3. For the triggering of GNSS measurement in the connected state, it is possible to consider: GNSS measurement triggered by the UE; or GNSS measurement triggered by the network.

As described above, in the related discussion, the capabilities of the IoT terminals are enhanced, and the UE may perform the GNSS positioning operation in the RRC connected state. Accordingly, the network side may need to know the GNSS related information of the UE, in order for the network side to determine how to configure an appropriate measurement gap for the UE to perform the GNSS measurement. Therefore, when should the UE report the GNSS related information to the network so that the network configures an appropriate measurement gap for the UE is a problem that needs to be solved.

It should be understood that the terms “system” and “network” are generally used interchangeably herein. In this context, the term “and/or” is merely an association relationship that describes associated objects, indicating that there are three relationships, for example, A and/or B may indicate three situations: existence of A alone, existence of A and B simultaneously, and existence of B alone. In addition, the character “/” herein generally indicates that the related objects before and after the character is in a kind of “or” relationship.

It should be understood that the reference to “indicate” in the embodiment of the disclosure may be a direct indication, an indirect indication, or a representation of a related relationship. For example, A indicates B may represent A indicates B directly, for example, B may be acquired through A; A indicates B may also represent A indicate B indirectly, for example A indicates C, and B may be acquired through C; A indicates B may also represent a related relationship between A and B.

In the description of embodiments of the disclosure, the term “correspond” may represent a direct correspondence relationship or an indirect correspondence relationship between the two; the term “correspond” may also represent a related relationship between the two; the term “correspond” may also represent indicating and being indicated, configuring and being configured, etc.

For convenience of understanding of technical solutions in embodiments of the disclosure, the related technologies of embodiments of the disclosure will be illustrated below. The following related technologies, as alternatives, may be arbitrarily combined with the technical solutions in the embodiments of the disclosure, and they all fall within the scope of protection of the embodiments of the disclosure.

FIG. 2 is a schematic flowchart of a method for communication according to an embodiment of the disclosure. The method includes at least part of the following.

In operation S210, a terminal device receives configuration information, and the configuration information is used to configure the terminal device to report GNSS related information.

FIG. 3 is a schematic flowchart of a method for communication according to an embodiment of the disclosure. The method includes at least part of the following.

In operation S310, a first network device transmits configuration information, and the configuration information is used to configure a terminal device to report GNSS related information.

Herein, the terminal device may be an IoT terminal device.

The first network device may be a first access network device. The access network device may be any one of a base station, a gNB, an eNB, a satellite, or the like.

In some possible implementations, the first network device may be an access network device of a cell where the terminal device is currently located.

The operation that the first network device transmits the configuration information may be specifically that: the first network device transmits the configuration information to the terminal device. Accordingly, the operation that the terminal device receives the configuration information may be specifically that: the terminal device receives the configuration information from the first network device.

It should be noted that, before the first network device transmits the configuration information to the terminal device, the method further includes the following operation. The first network device determines whether to transmit the configuration information to the terminal device.

Herein, the operation that the first network device determines whether to transmit the configuration information to the terminal device may specifically include that: the first network device transmits the configuration information to the terminal device in case that the first network device itself supports the terminal device to perform the GNSS measurement in the connected state; and/or, the first network device does not transmit the configuration information to the terminal device in case that the first network device itself does not support the terminal device to perform the GNSS measurement in the connected state. Whether the first network device itself supports the terminal device to perform the GNSS measurement in the connected state may be determined by the first network device based on its own capabilities, and the capabilities possessed by the first network device itself are not exhaustive herein.

The configuration information is carried by one of: system information broadcast; a first RRC message; a first MAC CE; a first physical downlink control channel (PDCCH) command.

In an example, the configuration information may be carried in the system information broadcast. In this case, the configuration information may be transmitted by the first network device to all devices to which the first network device serves through the system information broadcast. The terminal device may be any one of all devices to which the first network device serves. Herein, any one of devices to which the first network device serves may refer to a device within the coverage range of the first network device.

Specifically, the configuration information may be carried in at least one of a system information block (SIB) 1, SIB 2, SIB 31, and the like in the system information.

In an example, the configuration information may be carried in a dedicated signaling corresponding to the terminal device. Specifically, the configuration information may be carried by any one of the first RRC message, the first MAC CE, and the first PDCCH command.

In this case, the operation that the first network device transmits the configuration information to the terminal device may specifically include that: the first network device transmits the configuration information to the terminal device in case that the first network device itself supports the terminal device in performing the GNSS measurement in the connected state and the terminal device supports performing the GNSS measurement in the connected state. Herein, whether the terminal device supports performing the GNSS measurement in the connected state may be reported to the network side in advance as capability information of the terminal device. Accordingly, the first network device on the network side may obtain the capability information of the terminal device in advance, and then determine whether the terminal device supports performing the GNSS measurement in the connected state.

In one embodiment, the first RRC message includes one of: a first RRC connection establishment message, a first RRC connection reestablishment message, a first RRC connection resume message, or a first RRC connection reconfiguration message.

The operation that first network device transmits the configuration information to the terminal device may be at least one of the following operations. The first network device may carry the configuration information through the first RRC connection establishment message and transmit the configuration information to the terminal device in the process of establishing an RRC connection with the terminal device. The first network device may carry the configuration information through the first RRC connection reestablishment message and transmit the configuration information to the terminal device in the process of reestablishing an RRC connection with the terminal device. The first network device may carry the configuration information through the first RRC connection resume message and transmit the configuration information to the terminal device in the process of resuming an RRC connection with the terminal device. The first network device may carry the configuration information through the first RRC connection reconfiguration message and transmit the configuration information to the terminal device in the process of reconfiguring an RRC connection with the terminal device.

It should be noted that, in this embodiment, the first RRC connection reconfiguration message is used to carry information except the indication information for indicating handover. That is to say, the first RRC connection reconfiguration message is not used in the handover scenario in this embodiment.

In one embodiment, the first PDCCH command may refer to first downlink control information (DCI) transmitted on PDCCH. That is to say, the configuration information may be carried by the first DCI.

The DCI format adopted by the first DCI may be set according to the actual situation. For example, the DCI format adopted by the first DCI may be any one of multiple DCI formats specified in relevant protocols, which is not limited in this embodiment.

After receiving the configuration information from the first network device, the terminal device may further perform the following operation that: the terminal device transmits the GNSS related information to the first network device. Accordingly, the first network device may further perform the following operation that: the first network device receives the GNSS related information reported by the terminal device.

The GNSS related information includes at least one of: a valid time duration of a GNSS measurement result, or a measurement time duration of a GNSS.

The valid time duration of the GNSS measurement result may refer to remaining time during which the GNSS measurement result is valid, or a remaining valid time duration of the GNSS measurement result. The GNSS measurement may refer to a GNSS position or a GNSS position fix.

The measurement time duration of the GNSS may be referred to as a GNSS position fix time duration for measurement, and specifically refers to a time required for the terminal device to perform the position fix (or position) measurement of the GNSS.

The GNSS related information may be carried by one of a third RRC message or a third MAC CE.

Herein, the third RRC message may be an uplink RRC message, and the third MAC CE may be an uplink MAC CE.

The third RRC message may include one of: a first RRC connection establishment completion message, a first RRC connection reestablishment completion message, a first RRC connection resume completion message, a first RRC connection reconfiguration completion message, or a first UE assistance information message.

Exemplary, if the configuration information is carried by the first RRC connection establishment message or the system information block when the first network device transmits the configuration information, the terminal device may use the first RRC connection establishment completion message to carry the GNSS related information. If the configuration information is carried by the first RRC connection reestablishment message or the system information block when the first network device transmits the configuration information, the terminal device may use the first RRC connection reestablishment completion message to carry the GNSS related information. If the configuration information is carried by the first RRC connection resume message or the system message block when the first network device transmits the configuration information, the terminal device may use the first RRC connection resume completion message to carry the GNSS related information. If the configuration information is carried by the first RRC connection reconfiguration message when the first network device transmits the configuration information, the terminal device may use the first RRC connection reconfiguration completion message to carry the GNSS related information. If the configuration information is carried by the first RRC connection reconfiguration message when the first network device transmits the configuration information, and the first RRC connection reconfiguration message includes a configuration that requires the terminal device to report assistance information, the terminal device may use the first UE assistance information message to carry the GNSS related information.

The solutions provided in the implementations described above are illustratively described with reference to FIG. 4, including the following operations.

In operation S401, a first network device transmits configuration information to a terminal device.

In operation S402, the terminal device reports GNSS related information to the first network device.

In some possible implementations, the first network device is an access network device of a cell where the terminal device is currently located. Furthermore, the first network device has already configured the terminal device to report the GNSS related information.

After the first network device receives the GNSS related information reported by the terminal device, the method further includes the following operations. The first network device transmits a second RRC message to the terminal device. The first network device receives the GNSS related information from the terminal device.

Accordingly, after the terminal device transmits the GNSS related information to the first network device, the method further includes the following operation. The terminal device determines whether to transmit the GNSS related information to the first network device in case that a second RRC message is received by the terminal device from the first network device.

Different from the implementations described above, the solution provided in this implementation is that, on the basis that the terminal device has already reported the GNSS related information to the first network device of the cell where the terminal device is currently located when the terminal device receives the second RRC message from the first network device again, the terminal device needs to determine whether to transmit the GNSS related information to the first network device again.

The second RRC message may not carry configuration information. The second RRC message is one of: a second RRC connection reestablishment message, a second RRC connection resume message, or a third RRC connection reconfiguration message. It should be noted that the third RRC connection reconfiguration message is used to carry information except the indication information for indicating handover. That is to say, the third RRC connection reconfiguration message is not used in the handover scenario.

Exemplary, the operation that the first network device transmits the second RRC message to the terminal device may be at least one of the following operations. The first network device may transmit the second RRC connection reestablishment message to the terminal device in the process of re-establishing an RRC connection with the terminal device. The first network device may transmit the second RRC connection resume message to the terminal device in the process of resuming an RRC connection with the terminal device. The first network device may transmit the third RRC connection reconfiguration message to the terminal device in the process of reconfiguring an RRC reconfiguration with the terminal device. The specific contents that may be carried in the second RRC connection reestablishment message, the second RRC connection resume message, and the third RRC connection reconfiguration message are not limited in this embodiment.

The operation that the terminal device determines whether to transmit the GNSS related information to the first network device includes the following operations.

The terminal device determines to transmit the GNSS related information to the first network device in case that the GNSS related information is transmitted within a second preset time duration before the second RRC message is received. Alternatively, the terminal device determines not to transmit the GNSS related information to the first network device in case that the GNSS related information is not transmitted within a second preset time duration before the second RRC message is received.

Specifically, the operation that the terminal device determines whether to transmit the GNSS related information to the first network device may include the following operations.

Upon receiving the second RRC message, the terminal device determines whether it has transmitted the GNSS related information to the first network device again within a second preset time duration before a time at which the second RRC message is received by the terminal device. If the terminal device has transmitted the GNSS related information within the second preset time duration, the terminal device determines to transmit the GNSS related information to the first network device again; or otherwise, the terminal device determines not to transmit the GNSS related information to the first network device again.

Furthermore, when the terminal device determines to transmit the GNSS related information to the first network device, the terminal device transmits the GNSS related information to the first network device.

The specific value of the second preset time duration may be set based on the actual situations, for example, the specific value of the second preset time duration may be 0.5 seconds, 1 second, 2 seconds, or longer or shorter, and will not be exhaustive herein.

The GNSS related information may also be carried by any one of the third RRC message or the third MAC CE, which will not be repeated herein.

The contents included in the GNSS related information transmitted by the terminal device to the first network device at different timings or different times may have the same type as the contents included in the GNSS related information in the embodiments described above, while the specific values may be the same or different. For example, the GNSS related information transmitted by the terminal device to the first network device for a first time may include at least one of a first valid time duration of the GNSS measurement result or a first measurement time duration of the GNSS. The GNSS related information transmitted by the terminal device to the first network device for a second time includes at least one of a second valid time duration of the GNSS measurement result or a second measurement time duration of the GNSS. Moreover, the first valid time duration and the second valid time duration may be the same or different, and the first measurement time duration and the second measurement time duration may be the same or different.

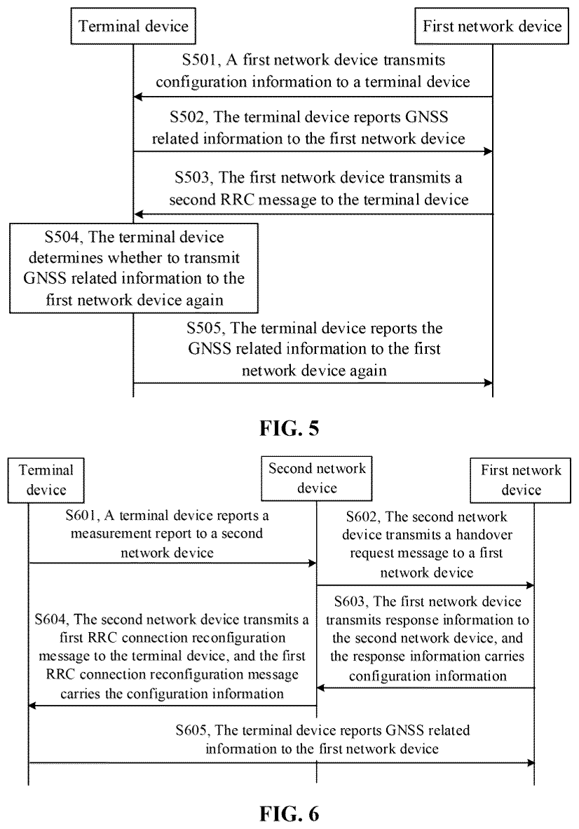

The solutions provided in the implementations described above are illustratively described with reference to FIG. 5, including the following operations.

In operation S501, a first network device transmits configuration information to a terminal device.

In operation S502, the terminal device reports GNSS related information to the first network device.

In operation S503, the first network device transmits a second RRC message to the terminal device.

In operation S504, the terminal device determines whether to transmit GNSS related information to the first network device again, and if so, operation S505 is performed; or otherwise, the process ends.

In operation S505, the terminal device reports the GNSS related information to the first network device again.

In each of the implementations described above, the processing of the terminal device within the coverage range of the first network device has been described. In actual scenarios, the terminal device will also be handed over among different network devices. The processing of the terminal device reporting the GNSS related information during the handover process will be described below.

In some possible implementations, the terminal device is handed over from a second network device to the first network device, and the second network device has not configured the terminal device to report the GNSS related information.

The second network device may be a source access network device for the terminal device, and the first network device is a target access network device for the terminal device.

In this implementation, the configuration information is carried by the first RRC connection reconfiguration message, and the first RRC connection reconfiguration message includes first indication information. The first indication information is used to indicate that the terminal device is handed over from the second network device to the first network device. If the first network device requires the terminal device to report the GNSS related information, the first network device may perform the following operation that: the first network device transmits the configuration information to the terminal device via the second network device. Accordingly, the operation that the terminal device receives the configuration information may be specifically that: the terminal device receives the configuration information from the first network device via the second network device.

Herein, the first indication information is reconfiguration WithSync information in the first RRC connection reconfiguration message. It should be understood that in some possible examples, the reconfiguration WithSync information may also be referred to as a reconfiguration WithSync field.

It should be noted that when the first RRC connection reconfiguration message carries the first indication information, the configuration information and the first indication information may occupy different fields in the first RRC connection reconfiguration message. Alternatively, the configuration information may be the content in the first indication information.

In this implementation, after receiving the configuration information from the first network device, the terminal device may further perform the following operation that: the terminal device transmits the GNSS related information to the first network device. Accordingly, the first network device may perform the following operation that: the first network device receives the GNSS related information reported by the terminal device.

Herein, the GNSS related information is carried by the third RRC message, and specifically, the GNSS related information may be carried by the first RRC connection reconfiguration completion message. The contents included in the GNSS related information are the same as those of the embodiments described above, and will not be repeated herein.

The solution provided in this implementation is illustratively described with reference to FIG. 6.

In operation S601, a terminal device reports a measurement report to a second network device.

Herein, the measurement report may include at least one of: a device identifier(s) of a candidate network device(s) or a signal intensity(s) of a candidate network device(s). The signal intensity of the candidate network device may include a reference signal receiving power (RSRP) measurement result and/or a reference signal receiving quality (RSRQ) measurement result.

In operation S602, the second network device determines a first network device as a target network device of the terminal device based on the measurement report, and the second network device transmits a handover request message to the first network device.

Herein, the operation that the second network device determines the first network device as the target network device of the terminal device based on the measurement report may include that: the second network device selects, based on the measurement report, the first network device having the largest signal intensity as the target network device for the handover. It should be understood that this is merely an exemplary description, and is not intended to limit the implementation in which the target network device is selected during the handover process.

In operation S603, the first network device receives the handover request message from the second network device. The first network device transmits respond information to the second network device, and the response information carries configuration information.

Specifically, the first network device determines whether the terminal device is required to report the GNSS related information when receiving the handover request message from the second network device. If needed, the first network device transmits respond information to the second network device, the response information carries configuration information, and the response information is further used to confirm that the terminal device is allowed to access.

The operation that the first network device determines whether the terminal device is required to report the GNSS related information may include that: the first network device determines that the terminal device is required to report the GNSS related information, when the first network device itself supports the terminal device in performing GNSS measurement in a connected state and the terminal device supports performing the GNSS measurement in the connected state. The specific processing of the determination of the first network device is the same as those of the embodiments described above, and will not be repeated herein.

It should be further noted that the operation that the first network device receives the handover request message from the second network device may be that: the first network device receives the handover request message through an Xn interface between the first network device and the second network device. The operation that the first network device transmits the response information to the second network device may be that: the first network device transmits the response information through the Xn interface between the first network device and the second network device, and the response information may be a handover request confirmation message.

Alternatively, the operation that the first network device receives the handover request message from the second network device may be that: the first network device receives the handover request message from the second network device through an S1 interface between the first network device and a core network device. The operation that the first network device transmits the response information to the second network device may be that: the first network device transmits the response information to the core network device through the S1 interface between the first network device and the core network device; and the core network device transmits the response information to the second network device through an S1 interface between the core network device and the second network device.

Herein, the operation that the first network device transmits the response information to the core network device through the S1 interface between the first network device and the core network device may be that: the first network device transmits a handover request confirmation message to the core network device through the S1 interface between the first network device and the core network device. The operation that the core network device transmits the response information to the second network device through the S1 interface between the core network device and the second network device may be that: the core network device transmits a handover command to the second network device through the S1 interface between the core network device and the second network device.

In operation S604, the second network device transmits a first RRC connection reconfiguration message to the terminal device, and the first RRC connection reconfiguration message carries the configuration information.

Specifically, when the second network device receives the response information, the configuration information carried in the response information may be added by the second network device into the first RRC connection reconfiguration message, and the first indication information may be added into the first RRC connection reconfiguration message. The second network device then transmits the first RRC connection reconfiguration message to the terminal device.

In operation S605, the terminal device reports GNSS related information to the first network device.

In some possible implementations, the terminal device is currently in the handover process of handing over from the first network device to the third network device. Furthermore, the first network device has configured the terminal device to report the GNSS related information.

After the first network device receives the GNSS related information reported by the terminal device, the method further includes the following operations.

The first network device transmits a handover request message for the terminal device to a third network device, and the handover request message carries the GNSS related information.

The first network device transmits second indication information to the terminal device when response information is received by the first network device from the third network device. The second indication information is used to indicate that the terminal device is handed over from the first network device to the third network device. Herein, the second indication information is carried by a second RRC connection reconfiguration message. The second indication information is reconfiguration WithSync information in the second RRC connection reconfiguration message.

That is to say, when the first network device has locally acquired the GNSS related information reported by the terminal device and during the handover process of the terminal device from the first network device to the third network device, the first network device, as a source network device, transmits the GNSS related information reported by the terminal device to the third network device through the handover request message, so that a target network device, i.e., the third network device, can efficiently acquire the GNSS related information of the terminal device. Furthermore, the third network device may also control the GNSS measurement of the terminal device based on the GNSS related information of the terminal device. For example, the third network device may allocate a corresponding measurement gap to the terminal device based on a GNSS measurement time duration included in the GNSS related information of the terminal device, so that the terminal device performs GNSS measurement based on the measurement gap, or the like. It should be understood that this is merely an exemplary description. The specific processing of the third network device controlling the GNSS measurement of the terminal device based on the GNSS related information of the terminal device may be the same as the content specified in relevant protocols, and will not be exhaustive herein.

In a possible example, the operation that the first network device transmits a handover request message for the terminal device to a third network device may include that: the first network device transmits the handover request message for the terminal device to the third network device through an Xn interface between the first network device and the third network device. Accordingly, the operation that the first network device receives the response information from the third network device may specifically include that: the first network device receives the response information from the third network device through the Xn interface. Herein, the response information may be used to confirm that the terminal device is allowed to access, and the response message may specifically be a handover request confirmation message.

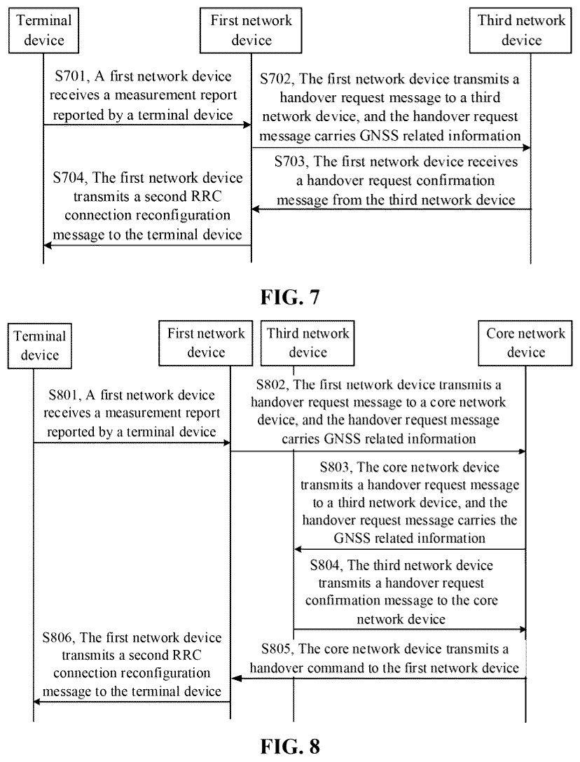

Taking FIG. 7 as an example, the operation that the first network device transmits a handover request message for the terminal device to a third network device, may include the following operations.

In operation S701, a first network device receives a measurement report reported by a terminal device.

After receiving the measurement report reported by the terminal device, the first network device may select the third network device based on the measurement report as the target network device for the handover.

Herein, the operation that the first network device selects the third network device based on the measurement report as the target network device for the handover, may include that: the first network device selects, based on the measurement report, the third network device having the largest signal intensity as the target network device for the handover. The measurement report may include at least one of: a device identifier(s) of a candidate network device(s) or a signal intensity(s) of a candidate network device(s). The signal intensity of the candidate network device may include a reference signal receiving power (RSRP) measurement result and/or a reference signal receiving quality (RSRQ) measurement result. It should be understood that this is merely an exemplary description, and is not intended to limit the implementation in which the target network device is selected during the handover process.

In operation S702, the first network device transmits a handover request message to a third network device, and the handover request message carries GNSS related information.

When the first network device receives the response information from the third network device, the specific processing of the first network device transmitting the second indication information to the terminal device is still described with reference to FIG. 7, and includes the following operations.

In operation S703, the first network device receives a handover request confirmation message from the third network device.

In operation S704, the first network device transmits a second RRC connection reconfiguration message to the terminal device. The second RRC connection reconfiguration message carries second indication information, and the second indication information is used to indicate that the terminal device is handed over from the first network device to the third network device.

In yet another possible example, the operation that the first network device transmits a handover request message for the terminal device to a third network device may include that: the first network device transmits the handover request message to a core network device through an S1 interface between the first network device and the core network device, and the core network device transmits the handover request message to the third network device through an S1 interface between the core network device and the third network device. Accordingly, the operation that the first network device receives the response information from the third network device may specifically include that: the third network device transmits the response information through the S1 interface between the third network device and the core network device; and the core network device transmits the response information through the S1 interface between the core network device and the first network device. Herein, the response information may be used to confirm that the terminal device is allowed to access.

Herein, the operation that the third network device transmits the response information through the S1 interface between the third network device and the core network device may include that: the third network device transmits a handover request confirmation message through the S1 interface between the first network device and the core network device. The operation that the core network device transmits the response information through the S1 interface between the core network device and the first network device may include that: the core network device transmits a handover command through the S1 interface between the core network device and the first network device.

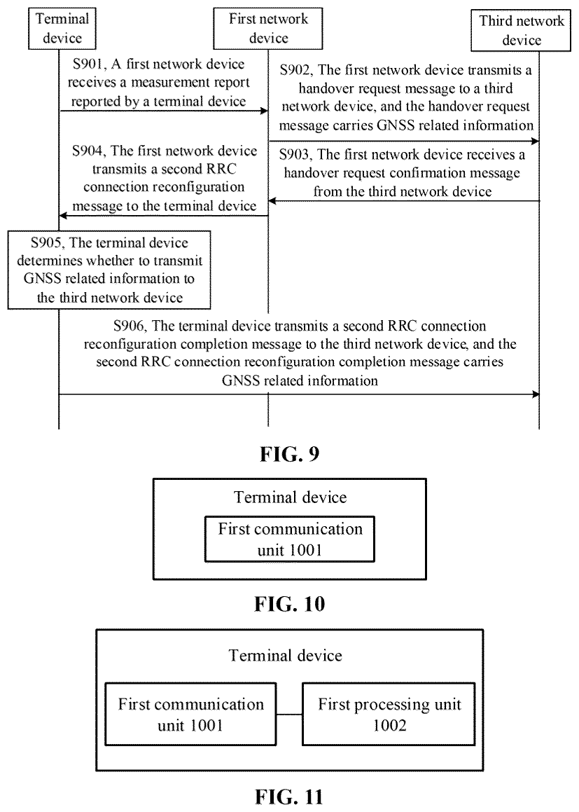

Taking FIG. 8 as an example, the operation that the first network device transmits a handover request message for the terminal device to a third network device may include the following operations.

In operation S801, a first network device receives a measurement report reported by a terminal device.

In operation S802, the first network device transmits a handover request message to a core network device, and the handover request message carries GNSS related information.

In operation S803, the core network device transmits a handover request message to a third network device, and the handover request message carries the GNSS related information.

When the first network device receives the response information from the third network device, the specific processing of the first network device transmitting the second indication information to the terminal device is still described with reference to FIG. 7, and includes the following operations.

In operation S804, the third network device transmits a handover request confirmation message to the core network device.

In operation S805, the core network device transmits a handover command to the first network device.

In operation S806, the first network device transmits a second RRC connection reconfiguration message to the terminal device. The second RRC connection reconfiguration message carries second indication information, and the second indication information is used to indicate that the terminal device is handed over from the first network device to the third network device.

Furthermore, although not illustrated in FIG. 7 and FIG. 8, after receiving the second RRC connection reconfiguration message, the terminal device may transmit a second RRC connection reconfiguration completion message to the third network device. The second RRC connection reconfiguration completion message may indicate that the terminal device has accessed the third network device, that is, the handover of the terminal device is successful.

In some possible implementations, the terminal device is currently in the handover process of switching from the first network device to the third network device. That is to say, the first network device is a source access network device for the terminal device, and the third network device is a target access network device for the terminal device. Moreover, the first network device has required the terminal device to report the GNSS related information. Furthermore, the terminal device may determine whether to transmit the GNSS related information to the third network device.

After the terminal device transmits the GNSS related information to the first network device, the method further includes that: the terminal device determines whether to transmit the GNSS related information to a third network device in case that second indication information is received by the terminal device from the third network device via the first network device. The second indication information indicates that the terminal device is handed over from the first network device to the third network device.

The second indication information is carried by a second RRC connection reconfiguration message, and the second RRC connection reconfiguration message is used to determine whether the third network device configures the terminal device to report the GNSS related information. The second indication information is reconfiguration WithSync information in the second RRC connection reconfiguration message.

The second RRC connection reconfiguration message may carry second indication information and configuration information, and the second indication information and the configuration information may be carried by different fields in the second RRC connection reconfiguration message, or the second indication information may contain the configuration information, both of which are within the scope of protection of this embodiment.

The third network device determines whether to configure the terminal device to report the GNSS related information by the following manner. The third network device determines to configure the terminal device to report the GNSS related information when the third network device itself supports the terminal device in performing GNSS measurement in connected state and the terminal device supports performing the GNSS measurement in the connected state. Alternatively, the third network device determines not to configure the terminal device to report the GNSS related information when the third network device itself does not support the terminal device performing the GNSS measurement in the connected state and/or the terminal device does not support performing the GNSS measurement in the connected state.

The operation that the terminal device determines whether to transmit the GNSS related information to the third network device may specifically include that: terminal device determines to transmit the GNSS related information to the third network device, when it is determined by the terminal device, based on the second RRC connection reconfiguration message, that the third network device configures the terminal device to report the GNSS related information, and the GNSS related information is transmitted by the terminal device within a first preset time duration before the second RRC connection reconfiguration message is received.

Alternatively, the operation that the terminal device determines whether to transmit the GNSS related information to the third network device may further include one of the following: the terminal device determines not to transmit the GNSS related information to the third network device, when it is determined by the terminal device, based on the second RRC connection reconfiguration message, that the third network device does not configure the terminal device to report the GNSS related information, and the GNSS related information is not transmitted by the terminal device within a first preset time duration before the second RRC connection reconfiguration message is received; or

the terminal device determines not to transmit the GNSS related information to the third network device, when it is determined by the terminal device, based on the second RRC connection reconfiguration message, that the third network device does not configure the terminal device to report the GNSS related information.

That is to say, during the handover process of the terminal device from the first network device to the third network device and within the first preset time duration before the second indication information is received by the terminal device, if the terminal device transmits the GNSS related information to the first network device, it is very likely that the third network device has not yet acquired the GNSS related information from the first network device. By adopting this implementation, it is possible to ensure that the third network device can acquire the latest GNSS related information for the terminal device in case that the third network device has configured the terminal device to report GNSS related information, thereby ensuring that the third network device controls the GNSS measurement of the terminal device based on the latest GNSS related information.

The operation that the GNSS related information is transmitted within the first preset time duration before the second RRC connection reconfiguration message is received may include that: the terminal device has transmitted the GNSS related information to the first network device within the first preset time duration before the second RRC connection reconfiguration message is received by the terminal device.

The first preset time duration may be denoted by T, and the specific value of the first preset time duration may be set based on the actual situations. For example, the specific value of the first preset time duration may be 1 second, 2 seconds, or longer or shorter, and will not be exhaustive herein.

The terminal device determines, based on the second RRC connection reconfiguration message, whether the third network device configures the terminal device to report the GNSS related information by the following manner. When the second RRC connection reconfiguration message carries second indication information, the terminal device determines whether the second RRC connection reconfiguration message carries configuration information. If the configuration information is carried, it is determined by the terminal device that the third network device configures the terminal device to report the GNSS related information; and if the configuration information is not carried, the terminal device determines whether the second RRC connection reconfiguration message is an incremental configuration. If it is determined that the second RRC connection reconfiguration message is the incremental configuration, the terminal device determines that the third network device configures the terminal device to report the GNSS related information. Furthermore, the above manner further includes that: when the second RRC connection reconfiguration message does not carry the configuration information and the second RRC connection reconfiguration message is not an incremental configuration, the terminal device determines that the third network device does not configure the terminal device to report the GNSS related information.

Herein, the operation that it is determined that the third network device configures the terminal device to report the GNSS related information when the second RRC connection reconfiguration message is an incremental configuration, may include that: when the second RRC connection reconfiguration message is the incremental configuration, it is determined by the terminal device that whether the first network device configures the terminal device to report the GNSS related information, and if so, it is determined by the terminal device that the third network device configures the terminal device to report the GNSS related information.

Whether the second RRC connection reconfiguration message is an incremental configuration may be determined based on whether the second RRC connection reconfiguration message indicates a full configuration. Exemplary, the indication of the full configuration may be included in the second indication information in the second RRC connection reconfiguration message. For example, if the second indication information indicates “full configuration”, it represents that the current configuration is the full configuration; and if the second indication information does not indicate the “full configuration”, it represents that the current configuration is not the full configuration.

In another possible example, the operation that the terminal device determines whether to transmit the GNSS related information to the third network device may include that: when the terminal device determines, based on the second RRC connection reconfiguration message, that the third network device configures the terminal device to report GNSS related information, the terminal device determines to transmit the GNSS related information to the third network device; or, when the terminal device determines, based on the second RRC connection reconfiguration message, that the third network device does not configure the terminal device to report GNSS related information, the terminal device determines not to transmit the GNSS related information to the third network device. That is to say, when a handover command (i.e., the second indication information carried by the second RRC connection reconfiguration message) is received by the terminal device, if the terminal device determines that the third network device configures the terminal device to report the GNSS related information, the terminal device transmits the GNSS related information to the third network device. In this example, the manner in which the terminal device determines whether the third network device configures the terminal device to report the GNSS related information is the same as those of the embodiments described above, and will not be repeated herein.

In the implementations described above, the contents included in the GNSS related information transmitted by the terminal device to the third network device are of the same type as the contents included in the GNSS related information transmitted by the terminal device to the first network device in the embodiments described above, while the specific values of them may be the same or different.

The GNSS related information transmitted by the terminal device to the third network device may be carried by a second RRC connection reconfiguration completion message, and the second RRC connection reconfiguration completion message is further used to confirm that the handover is completed.

It should be noted that the handover between the first network device and the third network device may be performed through the Xn interface or the S1 interface, and the description of the handover process of the Xn interface and the S1 interface is the same as that of the embodiments described above, and thus will not be repeated herein.

Referring to FIG. 9, taking the handover between the first network device and the third network device is performed through the Xn interface as an example, and the following operations are further included.

In operation S901, a first network device receives a measurement report reported by a terminal device.

In operation S902, the first network device transmits a handover request message to a third network device, and the handover request message carries GNSS related information.

In operation S903, the first network device receives a handover request confirmation message from the third network device.

In operation S904, the first network device transmits a second RRC connection reconfiguration message to the terminal device. The second RRC connection reconfiguration message carries second indication information, and the second indication information is used to indicate that the terminal device is handed over from the first network device to the third network device.

In operation S905, the terminal device determines whether to transmit the GNSS related information to the third network device. If so, operation S906 is performed; or otherwise, the terminal device transmits a second RRC connection reconfiguration completion message to the third network device. The terminal device accesses the third network device to perform subsequent operations, and this part is not shown in FIG. 9 for the sake of simplicity.

Herein, the manner in which the terminal device determines whether to transmit the GNSS related information to the third network device is the same as that of the embodiments described above, and will not be repeated herein.

In operation S906, the terminal device transmits a second RRC connection reconfiguration completion message to the third network device, and the second RRC connection reconfiguration completion message carries the GNSS related information.

It can be seen that by adopting the above solutions, the terminal device may receive configuration information that is used to configure the terminal device to report the GNSS related information. In this way, the terminal device can report the GNSS related information at an appropriate time according to the configuration from the network side, thereby ensuring that the network side configures an appropriate measurement gap for the terminal device.

FIG. 10 is a schematic structural diagram of compositions of a terminal device according to an embodiment of the disclosure, and the terminal device includes a first communication unit 1001.

The first communication unit 1001 is configured to receive configuration information, and the configuration information is used to configure the terminal device to report GNSS related information.

The first communication unit is configured to receive the configuration information from the first network device.

The configuration information is carried by one of: a system information broadcast; a first RRC message; a first MAC CE; or a first PDCCH command.

The first RRC message includes one of: a first RRC connection establishment message, a first RRC connection reestablishment message, a first RRC connection resume message, or a first RRC connection reconfiguration message.

The configuration information is carried by the first RRC connection reconfiguration message, and the first RRC connection reconfiguration message includes first indication information. The first indication information is used to indicate that the terminal device is handed over from the second network device to the first network device.

The first communication unit is configured to receive the configuration information from the first network device via the second network device.

The first indication information is reconfigurationWithSync information in the first RRC connection reconfiguration message.

The first communication unit is configured to transmit the GNSS related information to the first network device.

On the basis of FIG. 10, as shown in FIG. 11, the terminal device further includes a first processing unit 1002.

The first processing unit 1002 is configured to determine whether to transmit the GNSS related information to a third network device in case that the first communication unit receives second indication information from the third network device via the first network device. The second indication information is used to indicate that the terminal device is handed over from the first network device to the third network device.

The first communication unit 1001 is configured to receive the second indication information from the third network device via the first network device.

The second indication information is carried by a second RRC connection reconfiguration message.

The first processing unit is configured to determine to transmit the GNSS related information to the third network device, in case that it is determined, based on the second RRC connection reconfiguration message, that the third network device configures the terminal device to report the GNSS related information, and the GNSS related information is transmitted within a first preset time duration before the second RRC connection reconfiguration message is received.

The first processing unit is configured to determine whether to transmit the GNSS related information to the first network device in case that a second RRC message is received from the first network device through a second communication unit. The second communication unit is configured to receive the second RRC message from the first network device.

The first processing unit is configured to: determine to transmit the GNSS related information to the first network device in case that the GNSS related information is transmitted within a second preset time duration before the second RRC message is received; or, determine not to transmit the GNSS related information to the first network device in case that the GNSS related information is not transmitted within a second preset time duration before the second RRC message is received.

The second RRC message is one of: a second RRC connection reestablishment message, a second RRC connection resume message, or a third RRC connection reconfiguration message.

The GNSS related information is carried by one of a third RRC message or a third MAC CE.

The GNSS related information includes at least one of: a valid time duration of a GNSS measurement result, or a measurement time duration of a GNSS.

The terminal device is an IoT terminal device.

The terminal device in the embodiment of the disclosure may implement corresponding functions of the access network device in the method embodiments described above. The flows, functions, implementations, and beneficial effects corresponding to various modules (sub-modules, units, components, etc.) in the access network device may refer to the corresponding descriptions in the method embodiments described above, and will not be repeated herein. The functions described with respect to various modules (sub-modules, units, components, etc.) in the access network device in the embodiment of the disclosure may be implemented by different modules (sub-modules, units, components, etc.), or may be implemented by the same module (sub-module, unit, component, etc.).

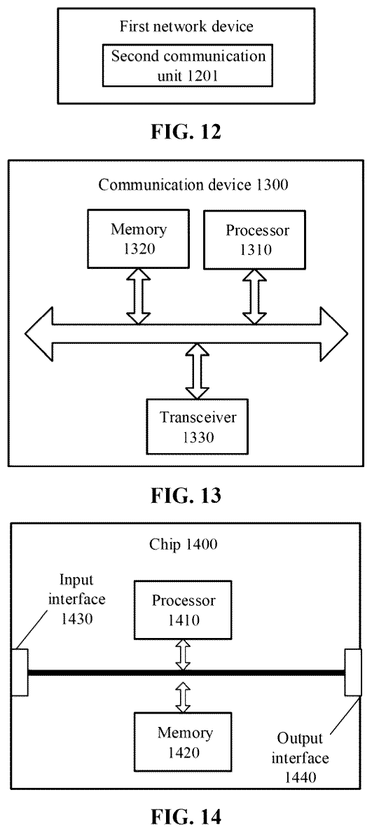

FIG. 12 is a schematic structural diagram of compositions of a first network device according to an embodiment of the disclosure, and the first network device includes a second communication unit 1201.

The second communication unit 1201 is configured to transmit configuration information, and the configuration information is used to configure a terminal device to report GNSS related information.

The second communication unit is configured to transmit the configuration information to the terminal device.

The configuration information is carried by at least one of: a system broadcast message; a first RRC message; a first MAC CE; or a first PDCCH command.

The first RRC message includes one of: a first RRC connection establishment message, a first RRC connection reestablishment message, a first RRC connection resume message, or a first RRC connection reconfiguration message.

The configuration information is carried by first indication information in the first RRC connection reconfiguration message. The first indication information is used to indicate that the terminal device is handed over from a second network device to the first network device.

The first indication information is reconfigurationWithSync information in the first RRC connection reconfiguration message.

The second communication unit is configured to receive the GNSS related information reported by the terminal device.

The GNSS related information is carried by one of a third RRC message or a third MAC CE.

The second communication unit is configured to transmit a handover request message for the terminal device to a third network device, and the handover request message carries the GNSS related information. The second communication unit is further configured to transmit second indication information to the terminal device in case that response information is received from the third network device, and the second indication information is used to indicate that the terminal device is handed over from the first network device to the third network device.

The second indication information is carried by a second RRC connection reconfiguration message, and the second RRC connection reconfiguration message is used to determine whether the third network device configures the terminal device to report the GNSS related information.

The second communication unit is configured to transmit a second RRC message to the terminal device, and receive the GNSS related information from the terminal device.

The second RRC message is one of: a second RRC connection reestablishment message, a second RRC connection resume message, or a third RRC connection reconfiguration message.

The GNSS related information includes at least one of: a valid time duration of a GNSS measurement result, or a measurement time duration of a GNSS.

The terminal device is an IoT terminal device.

The first network device in the embodiment of the disclosure may implement corresponding functions of the first network device in the method embodiments described above. The flows, functions, implementations, and beneficial effects corresponding to various modules (sub-modules, units, components, etc.) in the first network device may refer to the corresponding description in the method embodiments described above, and will not be repeated herein. It should be noted that the first network device may further include a second processing unit that may perform operations such as determination, but is not illustrated in FIG. 12. The functions described with respect to various modules (sub-modules, units, components, etc.) in the first network device in the embodiment of the disclosure may be implemented by different modules (sub-module, unit, component, etc.), or may be implemented by the same module (sub-module, unit, component, etc.).

FIG. 13 is a schematic structural diagram of a communication device 1300 according to an embodiment of the disclosure. The communication device 1300 includes a processor 1310 that may invoke and execute a computer program from a memory to cause the communication device 1900 to implement the methods in the embodiments of the disclosure.

In one possible implementation, the communication device 1300 may further include a memory 1320. The processor 1310 may invoke and execute a computer program from the memory 1320 to cause the communication device 1300 to implement the method in the embodiments of the disclosure.

The memory 1320 may be a separate device independent of the processor 1310, or may be integrated in the processor 1310.

In one possible implementation, the communication device 1300 may further include a transceiver 1330, and the processor 1310 may control the transceiver 1330 to communicate with other devices. Specifically, the transceiver may transmit information or data to other devices, or receive information or data from other devices.

The transceiver 1330 may include a transmitter and a receiver. The transceiver 1330 may further include antennas, and the number of antennas may be one or more.

In one possible implementation, the communication device 1300 may be the terminal device in the embodiments of the disclosure, and the communication device 1300 may implement corresponding processes implemented by the terminal device in the methods of the embodiments of the disclosure, which will not be repeated herein for the sake of simplicity.

In one possible implementation, the communication device 1300 may be the first network device in the embodiments of the disclosure, and the communication device 1300 may implement corresponding processes implemented by the first network device in the methods of the embodiments of the disclosure, which will not be repeated herein for the sake of simplicity.

FIG. 14 is a schematic structural diagram of a chip 1400 according to an embodiment of the disclosure. The chip 1400 includes a processor 1410 that may invoke and execute a computer program from a memory to implement the methods in the embodiments of the disclosure.

In one possible implementation, the chip 1400 may further include a memory 1420. The processor 1410 may invoke and execute a computer program from the memory 1420 to implement the method performed by a terminal device or a first network device in the embodiments of the disclosure.

The memory 1420 may be a separate device independent of the processor 1410, or may be integrated in the processor 1410.

In one possible implementation, the chip 1400 may further include an input interface 1430. The processor 1410 may control the input interface 1430 to communicate with other devices or chips, specifically to acquire information or data from other devices or chips.

In one possible implementation, the chip 1400 may further include an output interface 1440. The processor 1410 may control the output interface 1440 to communicate with other devices or chips, specifically to output information or data to other devices or chips.

In one possible implementation, the chip may be applied to the terminal device in the embodiments of the disclosure, and the chip may implement corresponding processes implemented by the terminal device in the methods of the embodiments of the disclosure, which will not be repeated herein for the sake of simplicity.

In one possible implementation, the chip may be applied to the first network device in the embodiments of the disclosure, and the chip may implement corresponding processes implemented by the first network device in the methods of the embodiments of the disclosure, which will not be repeated herein for the sake of simplicity.

The chip applied to the terminal device or the first network device may be the same chip or different chips.

It should be understood that the chip mentioned in the embodiments of the disclosure may also be referred to as a system-level chip, a system chip, a chip system, or a system on chip.

The processor mentioned above may be a general-purpose processor, a digital signal processor (DSP), a field programmable gate array (FPGA), an application specific integrated circuit (ASIC) or other programmable logic devices, a transistor logic device, a discrete hardware component, or the like. Herein, the general-purpose processor mentioned above may be a microprocessor, or any conventional processor or the like.

The memory mentioned above may be a volatile memory or a non-volatile memory, or may include both a volatile memory and a non-volatile memory. Herein, the non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that the above memory is an illustrative but not limiting illustration. For example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a direct rambus RAM (DRRAM), etc. That is to say, the memory in the embodiments of the disclosure is intended to include but not limited to these and any other suitable types of memories.

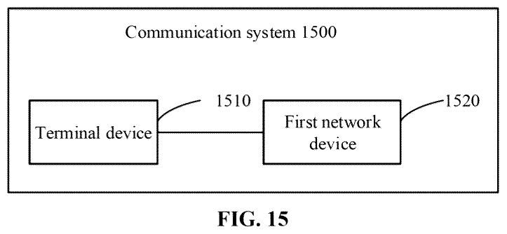

FIG. 15 is a schematic block diagram of a communication system 1500 according to an embodiment of the disclosure. The communication system 1500 includes a terminal device 1510 and a first network device 1520.

The terminal device 1510 may be used to implement the corresponding functions implemented by the terminal device in the above method, and the first network device 1520 may be used to implement the corresponding functions implemented by the first network device in the above method. For the sake of simplicity, it will not be repeated herein.

In the embodiments described above, it may be implemented in whole or in part by software, hardware, firmware, or any combination thereof. When implemented by using software, it may be implemented in whole or in part in the form of a computer program product. The computer program product includes one or more computer instructions. When the computer program instructions are loaded and executed on a computer, processes or functions in the embodiments of the disclosure are generated in whole or in part. The computer may be a general-purpose computer, a dedicated computer, a computer network, or other programmable devices. The computer instructions may be stored in a computer readable storage medium, or may be transmitted from one computer readable storage medium to another computer readable storage medium. For example, the computer instructions may be transmitted from one website, computer, server, or data center to another website, computer, server, or data center in a wired (e.g. coaxial cable, fiber optic, digital subscriber line (DSL)) or wireless (e.g. infrared, wireless, microwave, etc.) way. The computer-readable storage medium may be any available medium accessible by a computer or a data storage device containing a server, a data center and the like integrated by one or more available media. The available medium may be a magnetic medium (e.g., a floppy disk, a hard disk, a magnetic tape), an optical medium (e.g., a DVD), or a semiconductor medium (e.g., a solid state disk (SSD)), etc.

It should be understood that in the embodiments of the disclosure, the size of the sequence numbers of the processes described above does not imply the sequence of execution. The sequence of execution of the processes should be determined based on their functions and inherent logics, and should not constitute any limitation on the implementation of the embodiments of the disclosure.

Those skilled in the art may clearly understand that the specific working processes of the systems, devices, and units described above may refer to the corresponding processes in the above method embodiments, which will not be repeated herein for convenience and conciseness of the description.

The above description is only the specific embodiments of the disclosure, but the scope of protection of the disclosure is not limited thereto. Any change or replacement obvious to the skilled person familiar with the technical field within the technical scope disclosed by the disclosure shall be covered within the scope of protection of the disclosure. Therefore, the scope of protection of the disclosure shall be defined by the appended claims.

1.-67. (canceled)

68. A method for communication, comprising:
receiving, by a terminal device, configuration information, wherein the configuration information is used to configure the terminal device to report global navigation satellite system (GNSS) related information.

69. The method of claim 68, wherein the configuration information is carried by one of:
system information broadcast;
a first radio resource control (RRC) message;
a first medium access control (MAC) control element (CE); or
a first physical downlink control channel (PDCCH) command.

70. The method of claim 69, wherein the first RRC message comprises one of: a first RRC connection establishment message, a first RRC connection reestablishment message, a first RRC connection resume message, or a first RRC connection reconfiguration message.

71. The method of claim 69, wherein receiving, by the terminal device, the configuration information, comprises:
receiving, by the terminal device, the configuration information from a first network device.

72. The method of claim 70, wherein the configuration information is carried by the first RRC connection reconfiguration message, and the first RRC connection reconfiguration message comprises first indication information; wherein the first indication information indicates that the terminal device is handed over from a second network device to a first network device; and
wherein receiving, by the terminal device, the configuration information comprises: receiving, by the terminal device, the configuration information from the first network device via the second network device.

73. The method of claim 71, further comprising:
transmitting, by the terminal device, the GNSS related information to the first network device.

74. The method of claim 73, wherein after transmitting, by the terminal device, the GNSS related information to the first network device, the method further comprises:
determining, by the terminal device, whether to transmit the GNSS related information to the first network device in case that a second RRC message is received by the terminal device from the first network device.

75. The method of claim 68, wherein the GNSS related information comprises at least one of: a valid time duration of a GNSS measurement result, or a measurement time duration of a GNSS.

76. A terminal device, comprising:
a processor, a memory and a transceiver, wherein the memory is configured to store a computer program, and the processor is configured to invoke and execute the computer program stored in the memory to:
control the transceiver to receive configuration information, wherein the configuration information is used to configure the terminal device to report global navigation satellite system (GNSS) related information.

77. The terminal device of claim 76, wherein the configuration information is carried by one of:
system information broadcast;
a first radio resource control (RRC) message;
a first medium access control (MAC) control element (CE); or
a first physical downlink control channel (PDCCH) command.

78. The terminal device of claim 77, wherein the first RRC message comprises one of: a first RRC connection establishment message, a first RRC connection reestablishment message, a first RRC connection resume message, or a first RRC connection reconfiguration message.

79. The terminal device of claim 77, wherein the processor is configured to control the transceiver to receive the configuration information from a first network device.

80. The terminal device of claim 78, wherein the configuration information is carried by the first RRC connection reconfiguration message, and the first RRC connection reconfiguration message comprises first indication information; wherein the first indication information indicates that the terminal device is handed over from a second network device to a first network device; and
wherein the processor is configured to control the transceiver to receive the configuration information from the first network device via the second network device.

81. The terminal device of claim 79, wherein the processor is configured to control the transceiver to transmit the GNSS related information to the first network device.

82. The terminal device of claim 81, wherein the processor is further configured to:
determine whether to transmit the GNSS related information to the first network device in case that a second RRC message is received from the first network through the transceiver,
wherein the processor is configured to control the transceiver to receive the second RRC message from the first network device.

83. A first network device, comprising:
a processor and a memory, wherein the memory is configured to store a computer program, and the processor is configured to invoke and execute the computer program stored in the memory to:
control the transceiver to transmit configuration information, wherein the configuration information is used to configure a terminal device to report global navigation satellite system (GNSS) related information.

84. The first network device of claim 83, wherein the configuration information is carried by at least one of:
a system broadcast message;
a first radio resource control (RRC) message;
a first medium access control (MAC) control element (CE); or
a first physical downlink control channel (PDCCH) command.

85. The first network device of claim 84, wherein the first RRC message comprises one of: a first RRC connection establishment message, a first RRC connection reestablishment message, a first RRC connection resume message, or a first RRC connection reconfiguration message.

86. The first network device of claim 84, wherein the processor is configured to control the transceiver to transmit the configuration information to the terminal device.

87. The first network of claim 85, wherein the configuration information is carried by first indication information in the first RRC connection reconfiguration message; wherein the first indication information indicates that the terminal device is handed over from a second network device to the first network device.
